(19) United States
(12) Patent Application Publication
(10) Pub. No.: US 2003/0131702 A1
(43) Pub. Date: Jul. 17, 2003

(54) Method for cutting bond papers

(76) Inventors: Harmut Karl Sauer, Himmelstadt (DE); Johannes Georg Schaede, Wurzburg (DE); Hans Wyssmann, Zurich (CH)

Correspondence Address: Bugnion S A, 10 Route De Florissant, Case 375, Geneva, CH 1211, CH

(21) Appl. No.: 10/169,534

(22) PCT Filed: Dec. 22, 2000
(86) PCT No.: PCT/CH00/00684

(30) Foreign Application Priority Data
Dec. 29, 1999 (CH) 2395/99

(51) Int. Cl. B26D 7/06

(52) U.S. Cl. 83/23; 83/404

(57) ABSTRACT

The invention relates to a method comprising the following steps: a stack of sheets is moved under a blade in order to cut a first free strip of the stack of sheets; the first strip is cut; the stack of sheets is subsequently moved, whereupon it executes a first rotation and is guided under the blade once again in order to cut a second free strip; the second strip is cut; the stack is subsequently moved, whereupon it executes a second rotation and is guided under the blade once again in order to cut a third free strip; the third free strip and successive stacks of bond paper strips are cut, and; the successive stacks of bond paper strips are cut into individual bond papers.

### BACKGROUND OF THE INVENTION

The invention relates to a method for cutting stacked sheets of securities into individual securities, and to a machine for carrying out this method.

### PRIOR ARTS

Such methods and apparatuses are already known in the prior art. Securities, in particular bank notes, are printed onto sheets which each contain a specific number of these imprints of individual securities, which are arranged in matrix form, that is to say in rows and columns, the total number of imprints per sheet naturally depending on the dimensions of the sheet and the size of each imprint. Furthermore, a free strip must remain between each sheet edge and the imprints in each outer row or each outer column in order that the sheets can be gripped by tongs to be transported in the printing presses and can be held firmly on the rolls during the printing of the actual securities, these free strips further permit the imprint of reference marks on each sheet, with which the maintenance of register of tile sheets can be ensured if successive printing operations have to be superimposed without gaps or lined up in rows without gaps. This maintenance of register is also important when a plurality of various printing techniques are used at the same time and the sheet runs successively through a plurality of machines.

Following the printing of the individual securities, the sheets are stacked, each stack containing a specific number of sheets, for example 100. The sheet stacks are then fed to a machine which cuts them up into stacks of individual notes, which can then be sorted in order to separate out misprints or can be packed in packs. During the cutting operation, the free strips and the securities themselves are therefore cut.

A number of methods are known for cutting stacked sheets of securities to form stacks of individual securities. For example patent DE 195 15 705 shows such a method, according to which first of all the free strips are cut with a specific knife and then the individual securities arc cut by two other knives in two directions running at right angles to each other. In this case, therefore, first of all the free strips are cut and then the individual securities.

However, this method and the machine for its implementation have a number of disadvantages. For example, in this case at least three different knives have to be used for cutting the securities. In addition, at least three rotations of the sheet stack are required in order to cut the four free strips from the sheets which means that the execution time of this operation is increased.

Another cutting method with the associated apparatus is described in U.S. Pat. No. 4,283,902. According to this method, first of all the two longitudinal strips are cut in the running direction of the sheet stacks by two parallel knives, the sheets are then cut into strip stacks at right angles to the running direction and finally the securities are cut into individual securities following the fitting of wrappers. Four different knives are therefore required here in order to obtain stacks of securities from the sheet stacks.

The document DE 295 17 466 shows another cutting method which, before the cutting of the strips of securities, has tour successive cutting stages. After the first cut, rotations through 90°, then 180° and again 90° are necessary.

### SUMMARY OF THE INVENTION

The purpose of this invention is the improvement of the known cutting methods and the machines required, in particular by reducing the number of necessary operations for the processing of a stacked sheet of securities into a stack of individual securities.

The invention proposes in particular a method with which the expenditure of time for the cutting of the stacks of securities from the stacked sheets of securities can be reduced and, at the same time, fewer knives are needed for this operation.

The method according to this invention is defined by the features of patent claim 1.

The dependent patent claims 2 to 5 define specific types of embodiment of the method.

A machine for the application of the method as claimed in patent claims 1 to 5 is defined in the independent patent claim 6.

The dependent patent claims 7 to 10 define specific types of embodiment of the machine as claimed by the invention.

### BRIEF DESCRIPTIONS OF THE INVENTION

The invention is to be made more understandable by the description of one of its types of embodiment and the associated figures.

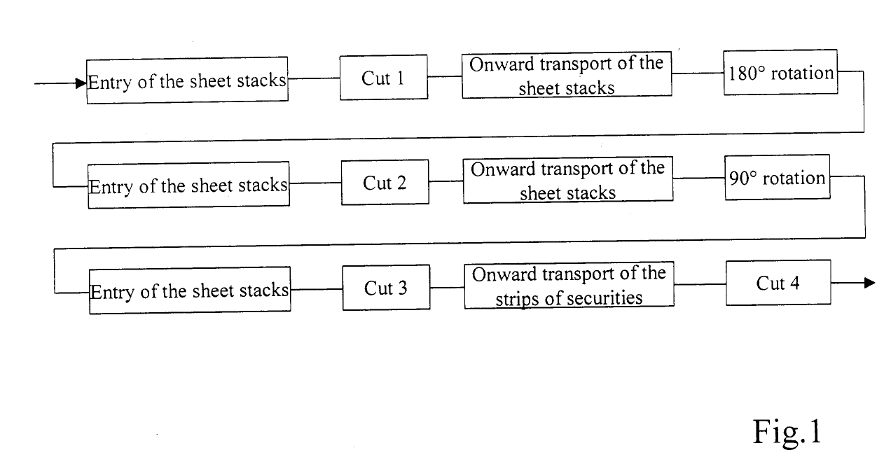

FIG. 1 is a block diagram of the method for cutting sheet stacks.

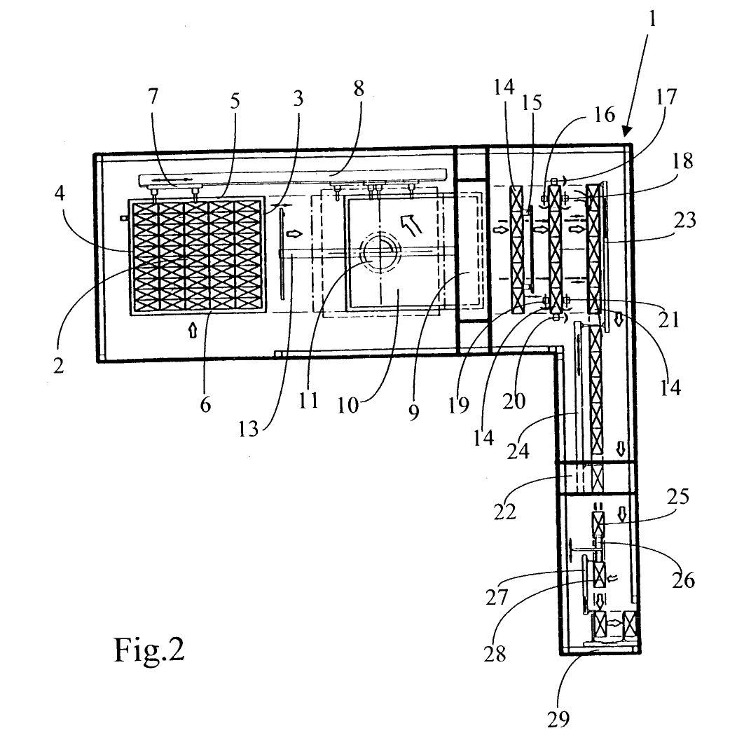

FIG. 2 is a schematic view from above of a machine for the application of the method as claimed by the invention.

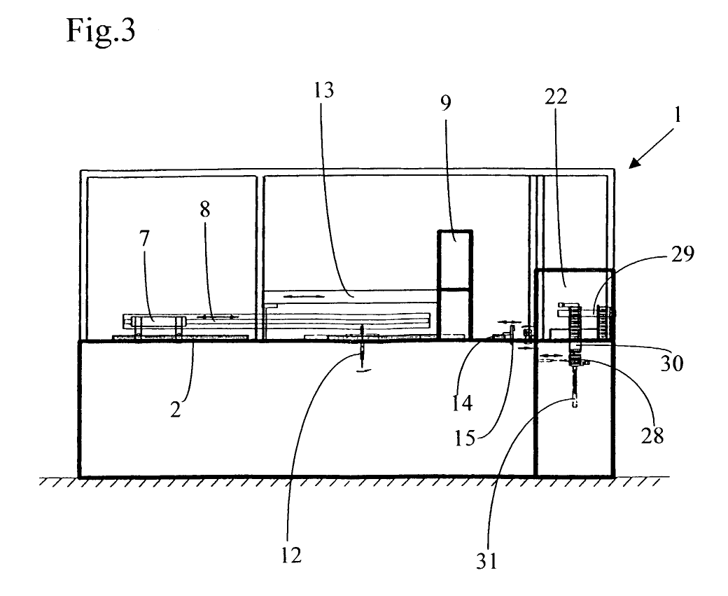

FIG. 3 is a schematic side view of the machine from FIG. 2.

### DETAILED DESCRIPTION OF THE PREFERRED EMBODIMENTS

The cutting method will be described first with reference to FIG. 1. According to the method of the invention, in the first step the sheet stacks are guided under the first knife of the machine and there a first free strip of the sheet stack is cut. This free strip lies between the edge or the stacked sheets and the lines, that is to say the rows or columns, having imprints of securities. The free strip forms a free space which, in particular, permits the individual sheets to be gripped by tongs without any risk that the imprints are damaged. In a first operation, this first free strip is then cut (“cut 1” in the figure), to be specific at right angles to the running direction of the sheet stack. Following the first cut, the sheets are moved rearward by suitable transport devices onto a turntable, which is known per se from the prior art, and the sheet stack is rotated through 180° on the turntable. The sheet stack is then guided under the first knife again and a second cutting operation (“cut 2” in the figure) is carried out on a second free strip parallel to the aforementioned first free strip. Following this second cutting operation, the sheet stack is again moved rearward onto the turntable and rotated through a further 90°. The sheet stack is then guided under the first knife again and a third cutting operation (“cut 3” in the figure) is carried out on a third free strip at right angles to the two first tree strips which have already been cut. Without further rotation of the sheet stack, the stacked sheets of securities can then be cut by the first knife into successive parallel strip stacks, by the stack being cycled onward each time by one strip width. This operation of cutting into successive strips is always illustrated in FIG. 1 by the block “cut 3”, since it is carried out by the first knife following the cutting of the third free strip.

Each of these strip stacks is collected in a strip collector. From the strip collector, the strips are then moved onward and cut by a second knife into stacks of individual securities (“cut 4” in the figure). The successive stacks of individual securities are transported out of the machine and subjected to the known final processing operations, for example counting of the securities, fitting wrappers or forming packs, each having 100 consecutively numbered securities, in a magazine.

A cutting machine 1 for the application of the method as claimed by the invention is described schematically with reference to FIGS. 2 and 3. The sheet stacks 2 with the imprints of securities are loaded into the cutting machine 1 manually or automatically. The stacked sheets provided with imprints contain the imprints arranged in rows and columns and also four free strips 3, 4, 5 and 6 between the sheet edge and the printed rows and columns. With the aid of a feed system with tongs 7, 8, the sheet stack 2 is guided under a first knife 9 for the first cutting operation, namely the cutting of the free strip 3 between the leading edge of the stack 2 in the running direction and the first line with imprints of securities running parallel to the first knife 9. The tongs feed system is a known system which, for example, is implemented with tongs 7 on a chain 8 or on an appropriate rail-guided system for the precise onward movement of the sheet stack 2. The first knife 9 is then activated and cuts the first free strip 3 of the sheet stack 2 in the vertical direction. The system with tongs 7, 8 then moves the sheet stack 2 rearward onto a rotary table 10. This rotary table 10 is implemented in a classical design comprising a turntable, which is driven by a motor 11 via a shaft 12 illustrated schematically in FIG. 3. Controlling the position of the motor 11 is carried out via a suitable electric or electronic drive system. Following the deposition of the sheet stack 2 in the correct position on the table, the turntable 10 firstly carries out a rotation through 180°, so that the edge of the sheet stack 2 which is now lying on the side of the first knife 9 is opposite the edge cut during the first cutting operation. The sheet stack 2 is then guided under the first knife 9 again via a teed means 13, which runs by above the sheet stack 2 and rests on the first-cut edge of the stack 2. The first knife 9 is lowered and cuts the second free strip 4 of the stack 2 in the second cutting operation. Following this second cutting operation, the sheet stack 2 is moved back onto the turntable 10 again by the system with tongs 7, 8, said turntable 10 this time executing a second rotation through 90° With the feed means 13, which rests on the side held firmly by the tongs 7, the sheet stack 2 is again guided under the first knife 9. After the two free strips 3 and 4 of the two edges of the stack 2 running at right angles to the first knife 9 have already been cut in the two first cutting operations, in the third cutting operation, the third free strip 5 is then cut and then, without further rotation of the sheet stack 2, successive strip stacks 14 of securities, as shown schematically in FIG. 2.

Each cut strip stack 14 of securities is gripped by a second tongs system 15 and transported into an alignment apparatus, where all the strips of securities are aligned. This alignment apparatus substantially comprises a plurality of moveable stops 16, 17, 18, 19, 20 and 21 and, after that, the strip stacks 14 are collected in a strip collector 28.

As soon as the collector 28 contains a previously defined number of strips, for example all the strips from a sheet stack, each strip stack 14 is removed from the collector 28, for example by moving the bottom of the collector 28 via a suitable mechanical or pneumatic apparatus which is illustrated schematically in FIG. 3 as number 31, and, by a suitable movement system, in this case two rams 23 and 24 arranged one behind another, is transported under a second knife 22 which is fitted at right alleles to the first knife 9. This second knife 22 then cuts the strip stacks 14 into stacks of individual securities 25 which, following cutting, are gripped by toners 26 and can be removed from the machine 1 by a third ram 27. These complete stacks 25 can be fed to further machines for final processing, which is known from conventional technology, for example to count the securities, provide them with wrappers or to pack them.

This machine 1 can therefore operate simultaneously with the two knives 9 and 22, that is to say while the strip stacks of a sheet stack are being cut by the knife 22 into stacks of individual securities, the next sheet stack is already being cut by the knife 9 into strip stacks.

Typically, a previously defined number of stacks 25 with individual securities is bundled to form a pack of consecutively numbered securities in a complete series, for example 1000 securities. In the example in FIG. 1, at the start, starting from the arrangement of the imprints in rows and columns (10 rows and 5 columns), a stack of 20 sheets is needed in order to obtain such a pack of 1000 individual securities.

The numbering method for the individual securities is known, and in this case the securities located in the same row and column on each sheet are provided with consecutive numbers, this consecutive numbering also being continued in adjacent stacks of securities, so that the sequence of stacks of individual securities cut by the second knife 22 is numbered consecutively. If these consecutive stacks are stacked, then a pack with consecutive numbering of the individual securities is obtained, for example a specific series of 1000 items.

Furthermore, the sheets running into this machine should preferably be fault-free, that is to say it should not be necessary to inspect each individual security note after it has been packed and wrapped. The sorting of these sheets is therefore in principle carried out before the stacked sheets run into the machine, so that the individual securities, fault-tree and consecutively numbered, can be bundled into packs.

The strips of securities are preferably moved under the first knife 9 at right angles to the running direction of the sheet stacks. Therefore, only a single second knife, which is fitted at right angles to the running direction of the strips of securities, is required to cut the strip stacks into stacks of individual securities.

The turntable can be arranged upstream or downstream of the first knife 9 in the running direction of the sheets. However, if the stacked sheets run one after another into the machine 1, then the turntable should preferably be fitted upstream of the first knife 9, however, in order that the cut of the free strips of a new sheet stack can begin even while the strip stacks of securities from the preceding sheet stack are being processed or cut into stacks of securities.

Although illustrative embodiments of the invention have been shown and described, a wide range of modification, change and substitution is contemplated in the foregoing disclosure and in some instances, some features of the present invention may be employed without a corresponding use of the other features. Accordingly, it is appropriate that the appended claims be construed broadly and in a manner consistent with the scope of the invention.

1. A method for cutting sheet stacks, in particular stacked sheets of securities, into individual securities, which is characterized by the following steps:
transporting a sheet stack under a knife to cut a first free strip of the sheet stack,
cutting the first strip,
transporting the sheet stack onward, executing a first rotation and guiding the sheet stack under the knife again to cut a second free strip,
cutting the second strip,
transporting the stack onward, executing a second rotation and guiding the sheet stack under the knife again to cut a third free strip,
cutting the third free strip and successive strip stacks of securities, and
cutting the successive strip stacks of securities into individual securities.

2. The method as claimed in patent claim 1, characterized in that the first rotation is a rotation through 180°.

3. The method as claimed in patent claim 1, characterized in that the second rotation is a rotation through 90°.

4. The method as claimed in patent claim 3, characterized in that the cutting of the sheet stacks runs a right angles to the running direction of the sheet stacks.
cutting of the sheet stacks runs at right angles to the running direction of the sheet stacks.

5. The method as claimed in one of patent claim 1, characterized in that the sheet stacks are transported counter to their running direction in order to be rotated.

6. A machine for the application of the method as claimed in one of patent claim 1, comprising means (7, 8) for the transport of the sheet stacks (2) and means of cutting (9, 22) the sheet stacks (2) into stacks with individual securities (25), characterized in that the cutting means comprise a first knife (9) for cutting free strips (3, 4, 5, 6) of the sheet stacks (2) and for cutting the sheet stacks (2) into strip stacks (14) of securities, and a second knife (22) for cutting the strip stacks (14) of securities into stacks of individual securities (25), and in that the machine comprises a rotary table (10) with which the sheet stacks (2) can be rotated.

7. The machine as claimed in patent claim 6, characterized in that the rotary table comprises a turntable (10) which is driven by a motor (11) and is set up to execute a first rotation of 90° and a second rotation of 180°.

8. The machine as claimed in patent claim 7, characterized in that the rotary table is accommodated in the machine (1) upstream of the first knife (9) in the running direction of the sheet stacks (2).

9. The machine as claimed in patent claim 8, characterized in that the knives (9, 22) are at right angles to each other.

10. The machine as claimed in patent claim 9, characterized in that the successive stacks of individual securities (25) are stacked to form packs (28) of consecutively numbered securities.
